(19) United States
(12) Patent Application Publication
(10) Pub. No.: US 2006/0246399 A1
(43) Pub. Date: Nov. 2, 2006

(54) Two-part ceramic dental implant

(76) Inventor: Peter A. Ehrl, Berlin (DE)

Correspondence Address: Norris, McLaughlin & Marcus P.A., 18th Floor, 875 Third Avenue, New York, NY, 10022, US

(21) Appl. No.: 11/377,103

(22) Filed: Mar. 16, 2006

(30) Foreign Application Priority Data
Mar. 16, 2005 (DE) 10 2005 013 200.6

(51) Int. Cl. A61C 8/00

(52) U.S. Cl. 433/201.1; 433/173

(57) ABSTRACT

The invention relates to a two-part tooth root implant for insertion in the jaw of humans or vertebrates, said tooth root implant being equipped with an enossal implant body 2 for anchoring in the bone and an implant abutment 1 for receiving an individually produced dental crown. Ceramic materials based on zirconium oxide or a zirconium oxide/aluminium oxide mixture are used as the material. The surface area of the dental implant is microstructurally enlarged.

The invention relates to a two-part tooth root implant for insertion in the jaw of humans or vertebrates, said tooth root implant being equipped with an enossal implant body 2 for anchoring in the bone and an implant abutment 1 for receiving an individually produced dental crown. Ceramic materials based on zirconium oxide or a zirconium oxide/aluminium oxide mixture are used as the material. The surface area of the dental implant is microstructurally enlarged.

In dental medicine, “implant” is the term given to an artificial tooth root used for fastening crowns, bridges or prostheses. It is permanently anchored in the bone in a toothless area of the jaw. When a single tooth is replaced, implants make it possible to retain the tooth substance of the neighbouring teeth, as the latter do not have to be ground; they also make it possible to also integrate comfortably seated permanent bridges even in places where a removable prosthesis would otherwise be inserted. In cases of advanced jaw degradation, they can be used for fixing a dental prosthesis.

One- and two-stage tooth root implant systems have been known for a long time. The earliest monobodies were found among the Mayas (Honduras, 7^{th} century AD). The early implants in the 20^{th} century were almost entirely monobodies. Even implants used today take this form on certain conditions, the most important condition being the immediate positive fit when inserted. The two-stage procedure has been known since the end of the 19^{th} century and has proven today to be the more effective and by far the most frequently applied method. Therefore virtually all implant systems involve the attachment of a post after the trouble-free healing of the tooth root (usually after three to six months).

Implant materials have to satisfy especially stringent requirements. They have to show optimum tissue compatibility, be absolutely safe in terms of allergies, and withstand all masticatory stressing like a natural tooth. An artificial tooth root can be expected to be exposed to severe mechanical stressing by mastication motions. The masticatory pressure can be as high as about 100 kP and in exceptional cases even as high as 700 kP. The fatigue and impact fracture behaviour of the material used for the artificial root are of special importance. Although many different materials have been tried in the past, almost all jaw implants today are made of titanium or titanium alloys. However, the metal titanium is not corrosion resistant. It has been demonstrated that small quantities of ions are released into the recipient's body. If it is too thin, fatigue fractures may occur. Many other materials have failed to become established in practice, as they do not heal in the desired manner. For example, implants of ceramic materials and Al₂O₃ in particular have been applied in a wide variety of forms (screws, arrow-type posts, extension implants). However, connective tissue healing (distance osteogenesis) tended to occur more frequently than with titanium implants. The area of direct bone deposition (contact osteogenesis) was smaller. For ceramic materials, impact fractures due to sudden force application are particularly dangerous. The Al₂O₃ ceramic implants used were unable to safely withstand these forces. Impact fractures occurred in the area of the ceramics as well as fatigue fractures of the abutments made of titanium. Because of the unavoidable fracture risk, these implants were removed from the market and development work was initially discontinued.

The latest-generation materials include technical ceramics made of zirconium oxide (EP 0 624 360 B1), whose surface enlargement has so far been problematical but indispensable for clinical application.

Ceramic implants as monobodies are familiar. DE 103 19 036 A1 describes a dental implant consisting of a base body with a threaded piece and a post, with the base body being of a single piece and consisting largely of zirconium oxide or a zirconium oxide/aluminium oxide mixture. Arranged between the threaded piece and the post is a tulip-shaped intermediate piece projecting beyond the thread diameter, as a result of which the dental implant can find support in the gingiva and jaw bone. Disadvantageous for this implant's ingrowth behaviour are the shape-related corners and edges that can lead to unwanted pitting. The production of this shape proves to be difficult. Furthermore, the smooth and extremely hard surface yields a small surface area, so that, in the event of bone deposition, little retention can be expected.

A single-piece dental implant based on zirconium oxide with an anchor part and an abutment part is known from DE 101 59 683 A1, whose surface is pretreated with a subtractive, ablative method or provided with a coating in order to support ossification. However, the patent specification fails to disclose any practicable implementation of an ablative method for roughening or microstructuring the ceramic surface.

The above-mentioned implants designed as single-piece workpieces also have the disadvantage that they are always exposed to a certain immediate load and hence micro-movements in the contact range and break through the physical integrity, thus opening a door to infection at the healing stage.

Ceramic implants as two-stage implants are also familiar. However, the abutments of these implants are also made of metallic materials, usually titanium. Because of the hardness of the ceramics, the combination of these two materials frequently results in fatigue fractures of the metal abutments and impact fractures of the thin ceramic sheathing of the post.

DE 196 38 232 B4 describes a dental implant made of high-strength material and an abutment part made of a treatable ceramic, which are connected via an intermediate cap and adhesive bonds. A base part is fastened to the top side of the implant. An additional pin anchors the base part both in the implant and in the abutment part. The disadvantages are its complex manufacture, reduced stability and the need for precise adjustment of the implant with its base part and pin as well as the additionally necessary attachment of the intermediate cap to this (four-part) implant system.

DE 200 04 526 U1 discloses a dental implant whose implant body tapers conically at the cervical end and has a self-cutting thread with a groove. The upper part engages positively with a drilled hole of the implant body and is secured against twisting. The coronal end of the implant body and the connection area have a matching diameter. Owing to the design of the head part and the lack of microstructuring, disadvantageous ingrowth behaviour can be assumed.

The object of the present invention is to provide a dental implant that improves osseointegration, the hygienic situation in the emergence area and the formation of an inter-implant papillary structure and that shows high stability.

The object of the invention is accomplished according to the independent claim. The subclaims contain preferred embodiments. Provided according to the invention is a two-part tooth root implant made of zirconium oxide or a zirconium oxide/aluminium oxide mixture with an enossal implant body 2 for anchoring in the bone and an implant abutment 1 to receive a dental crown, said implant body 2 being microstructured on its surface.

Surprisingly, it has been shown that the inventive combination of form, material and the microstructure of the surface of the dental implant yields improved ingrowth behaviour and in particular avoids disadvantageous pitting better than has been possible until now with ceramic implants. As a result, better and more stable biological incorporation is achieved in the long term without the disadvantages of metal implants such as those made of titanium.

In the meaning of the invention, a distinction is made in terms of form between macrostructure and microstructure. The term “macrostructure” describes in the present case the outer form visible with the naked eye. The term “microstructure” describes in the present case the form of the surface visible with the microscope and its modification.

The implant body 2 of the inventive tooth root implant consists preferably of a cylindrical base body 3 and a cylindrical head part 6, said base body 3 having a conically convergent form in the proximal base body area 4 and having an opening 12 and a thread 11, said head part 6 having a diameter identical to or smaller than the base body 3. It goes without saying that the opening 12 continues in the head part 6 and is thus also present in the head part 6. The special feature of the invention is that this form is realizable at all with the material zirconium oxide or a zirconium oxide/aluminium oxide mixture. Until now, it has not been possible to produce an interior cavity, as represented by the opening 12, for instance, reliably and without weakening the overall body. It is precisely this interior cavity that in the present case permits application as a two-part tooth root implant.

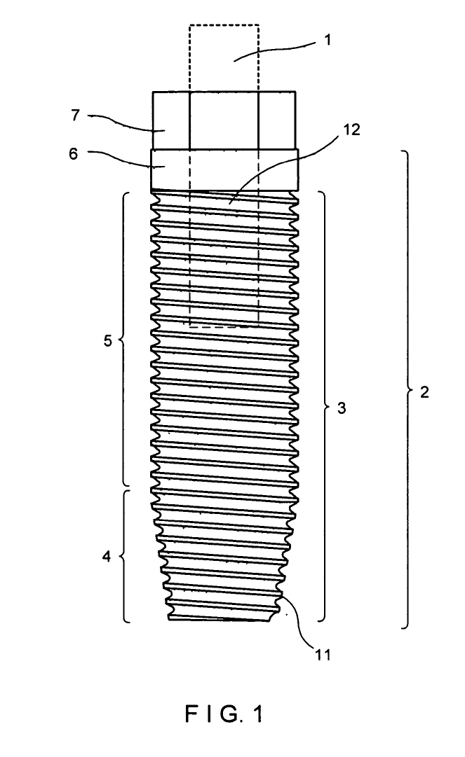

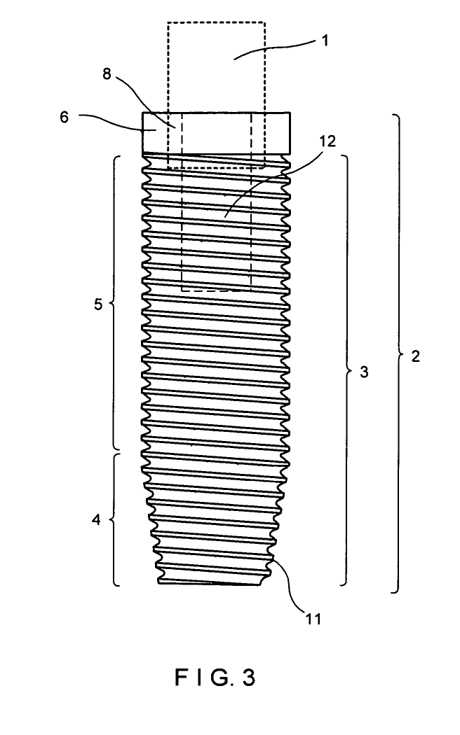

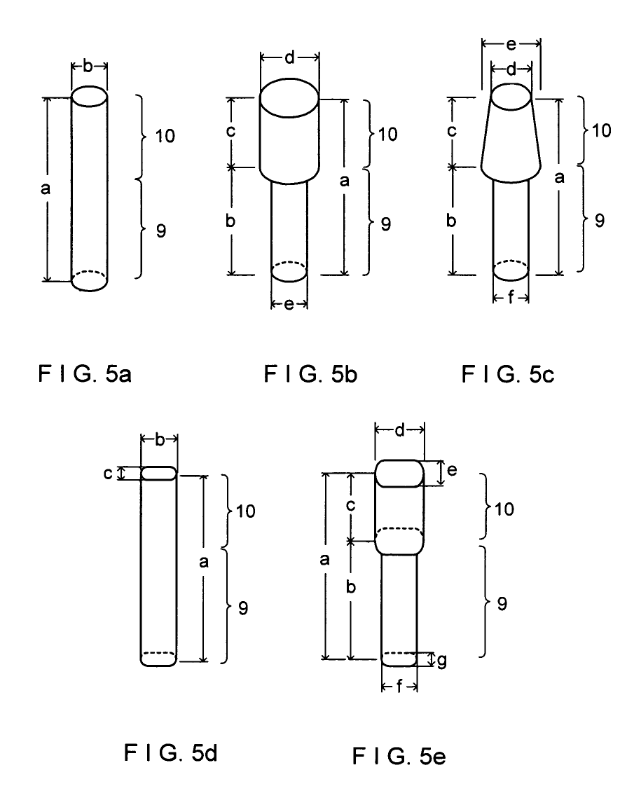

The macrostructure is thus characterized by a thread 11 that, in accordance with photo-elastic examinations, avoids sharp edges and extends over the entire base body 3. The base body can preferably have a height of 9 to 24 mm. The end located in the bone, the proximal base body area 4, tapers. This is beneficial for the preservation of neighbouring teeth; given appropriate bone preparation, it leads to a bone compression favourable for healing behaviour; and it can be used in soft bone for the expansion of the jaw bone which has often become narrow. Furthermore, the dental implant can be introduced better into the hole drilled in the jaw. The conical proximal area 4 is preferably 3 to 10 mm high and has an opening angle of 3 to 15°. In the emergence area, the diameter of the implant does not project beyond the diameter of the base body 3, which can be 3.75 to 6 mm. Preferred is a diameter of the head part 6 and/or outer force transmission element 7 that is smaller than the diameter of the base body 3. This has proven to be advantageous for the healing behaviour in this area. It can even happen that the bone grows over this area. Consequently, the bone degradation feared in the long term with implants, which occurs specifically in the implant's sensitive emergence area, can be prevented by the inventive dental implant. The head part 6 can have a height of, for example, 0.5 to 3 mm (see also FIGS. 1 and 3). The opening 12 is designed to receive a fixing pin 9 with superimposed post 10, which make up the implant abutment 1 as an integral piece (see also FIG. 5). As a result of the highly precise fit and new adhesive methods, a tight bond is achieved at the fixing pin 9 between the implant abutment 1 and enossal implant body 2.

Due to the improved properties of zirconium oxide ceramics, it is possible to choose the same ceramic material for both the enossal implant body 2 and the implant abutment 1, without for instance resorting to the circuitous method of the intermediate cap disclosed in DE 196 38 232 B4. The microstructure is characterized by a roughening of the material in the area of bone contact. This makes sense in terms of an enlargement of the surface, which has a direct and positive relationship to the strength and long-term behaviour of the inventive implant. Until now, ceramic implants have not had a treated surface, which has meant that the enossal surfaces of ceramic implants have not so far been modified. Because of the very smooth surface of ceramics, the undesirable loosening of the implant used to occur on exposure to high extraction forces. With the inventive treatment of the surface, this disadvantage is overcome.

Contrary to the view expressed in DE 101 59 683 A1, zirconium oxide ceramics are suitable for both mechanical and chemical surface structuring with ablative methods. The preferred mechanical ablative method in the sense of the invention is the abrading of zirconium oxide ceramics with a material that is coarser than the zirconium oxide surface, e.g. with diamond abrasives, blasting with particles such as diamond, zirconium oxide or aluminium oxide particles, sand of various grain sizes, corundum, cherry stone materials or other natural products, and/or processing with laser. An especially preferred mechanical ablative method is blasting with corundum. The production of the enlarged surface (microstructure) by blasting with corundum is effected at a defined pressure, with a defined particle size and at a uniform, defined speed of rotation of the implant. In an especially preferred embodiment of the mechanical ablative method, the surface is blasted with particles ranging from 25 to 120 μm in size. A particle size of at least 50 μm is preferably used, with the surface being blasted in particular at a pressure of 3 bar. The generated medium pore size, which exceeds about 50 μm, is particularly advantageous for the permanent enossal fixing of the inventive implant.

The preferred chemical ablative methods comprise, for example, etching with acids such as hydrofluoric acid, or with lyes such as caustic soda, chemical milling, laser etching and electro-ablative treatment. For the etching method, the concentration of the acid, the action time and a defined speed of rotation must be recorded as variables of the result to be achieved. Attempts are made to achieve a surface with a pore diameter of 1.0 to 2.0 μm termed “moderately rough”.

Also conceivable is the additional application of a suitable biocompatible or bioactive material onto the implant surface enlarged by microstructuring.

The zirconium oxide ceramic implants can achieve contact osteogenesis comparable to that of titanium implants, as a result of which the share of non-direct bone contact area is reduced. Stability in the bone is thus noticeably improved by the inventive implant.

In the area of emergence through the oral mucous membrane, on the other hand, the smooth surface is favourable for hygienic reasons, as there is less tendency for plaque, the film that leads to paradontosis and bone degradation, to be deposited. This is a further advantage of the inventive implant.

The inventive implant is produced separately in two parts that comprise the enossal implant body 2 and the implant abutment 1 to receive an individually produced tooth crown. Very much like a natural tooth, zirconium oxide ceramic implants can be treated with conventional dental instruments (diamond abrasives, water cooling). Shaping can also be performed in the same way as with a natural tooth. The extremely elaborate screwing-on of abutments, the processing in the laboratory, and X-ray controls of fitting precision, as required, for example, for titanium implants, are dispensed with. Individualization is therefore more possible than, for example, with titanium implants. This means a considerable simplification of the process and less specialized technical knowledge is demanded of the user.

The inventive implant is preferably employed as a so-called delayed late implant. After the extraction of a tooth, time is allowed for the healing of tooth-related inflammation and initial regeneration of the surrounding bone tissue before a hole is drilled whose diameter precisely matches that of the implant. The enossal implant body 2 is first implanted and the implant abutment 1 is only mounted after the healing phase. This has proven to be superior to a single-stage arrangement. However, this implantation method is not essential and the implant can also be employed in suitable cases as an immediate implant or late implant, in which case the one-part form of the inventive implant can be used. Single-piece implants will always have the rarer indication. The process of implantation is known to those skilled in the art.

The light colour of zirconium oxide is markedly superior to the colour of titanium in the aesthetically important area. With staining, a natural colouration can be additionally achieved. Special procedures and complicated abutments are not necessary.

Further advantages of the material are that, in so far as no bioactive materials are applied, it can be sterilized in the widely used autoclave and the length can be individually shortened within certain limits.

The enossal implant body 2 can be microstructured over its entire surface or parts thereof. The above-mentioned parts always comprise the base body 3, and they preferably comprise only the base body 3. In particular, the base body is completely microstructured on its surface. In an embodiment of the present invention, the head part 6 is also microstructured on its surface. This concerns particularly the portion of the head part that is situated in the root area and is enclosed by the jaw bone. As a result, improved osseointegration is achieved over the entire enossal implant body 2. The microstructure is generated with the methods already described and familiar to known to those skilled in the art.

In a further embodiment of the invention, the opening 12 is rotationally symmetrical. In a preferred embodiment, the rotational symmetry is realized with a circular cross section. The cross section is preferably constant, although it can also vary over the depth of the opening 12. The cross section and depth of the opening 12 define a hollow body whose walls, with the exception of the cover surface, are determined by the surrounding implant body 2. The opening 12 can be generated with a conventional cutting method, e.g. drilling, turning, milling, planing, impacting etc. In particular, the hollow body can be a drilled hole in the form of a hollow cylinder that can be produced without complications. However, it is technically difficult to produce a level base surface. Instead, a depression often arises for chip removal that, for instance, can have a rounding of 0.25 mm in the area of transition to the base surface. This production-related deviation from the ideal shape of the opening 12 is not to be interpreted as a new form in the sense of the invention.

In another embodiment of the invention, the opening 12 has an inner force transmission element 8 in the distal area (see also FIG. 3). In the meaning of the invention, the term “distal” denotes a position distant from the body or from the trunk. By comparison, “proximal” denotes a position that is close to the body or trunk. The inner force transmission element 8 preferably has a height that is smaller than the height of the head part 6. The height of the inner force transmission element 8 can also be equal or greater than the height of the head part 6. The diameter of the inner force transmission element 8 is expediently at least partially larger than the diameter of the opening 12 in the proximal area. The inner force transmission element 8 is used for screwing in the enossal implant body 2, which has an external thread 11, into the jaw. Screwing-in is performed with a suitable tool that temporarily enters into a positive connection with the inner force transmission element 8. In order to transmit the forces necessary for screwing-in, engaging of the two mating parts must be rotationally stabilized. Furthermore, rotational stabilization is advantageous for the fixing of the implant abutment 1 by means of a positive connection.

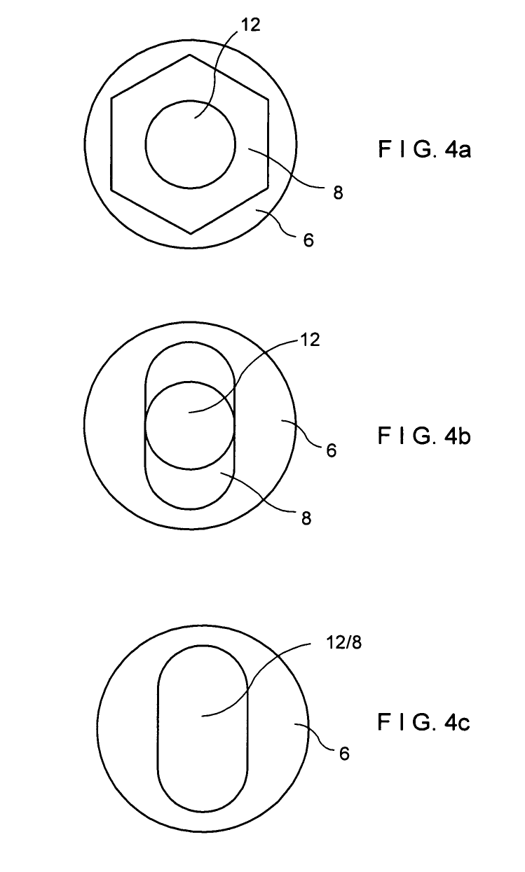

In a preferred embodiment of the present invention, the inner force transmission element 8 is not therefore rotationally symmetrical but has preferably an elliptical cross section, polygonal cross section or rectangular cross section with a semicircular face or two semicircular faces on opposite rectangular faces. The inner force transmission element 8 with a polygonal cross section forms a hollow prism whose walls are formed by the enossal implant body and on which the level base surface has at least three corner points. Especially preferred is a hollow body in the form of a hexagon socket (FIG. 4a). The inner force transmission element 8 with at least one adjoining semicircular face forms a longitudinal groove. By this is meant an elongate depression in the enossal implant body 2 on the inner side of the opening 12. A single longitudinal groove, two longitudinal grooves arranged opposite each other, or four longitudinal grooves in a cross arrangement are advantageously conceivable (FIG. 4b). The provision of such complicated openings 12 as shown in FIG. 4 has been realized for the first time in the teaching of the present application.

Over and above this, the entire opening 12 can have rotational stabilization and can thus be interpreted as an inner force transmission element 8 both in the distal and proximal area of the opening 12. In a further embodiment of the invention, the opening 12 is not therefore rotationally symmetrical. The screwing tool engages positively in the opening 12, and any depth of the positive joint can be chosen in relation to the forces to be applied. The screwing tool preferably exploits the entire opening 12. In a preferred embodiment of the present invention, the opening 12 is formed with an elliptical cross section, polygonal cross section or rectangular cross section with two semicircular faces on opposite rectangular faces (FIG. 4c). The preferred polygonal cross sections are a regular hexagon and a regular octagon. The continuous rotational stabilization of the opening 12 in turn performs a dual function. In addition to the described possibility of screwing in the enossal implant body 2 with the aid of a positively fitting tool, the implant abutment 1 is advantageously protected from twisting. Owing to this two-part function, it is not excluded that the rotational stabilization in the distal area (inner force transmission element 8) can differ from the rotational stabilization in the proximal area (opening 12).

Both the rotationally symmetrical and the rotationally asymmetrical opening 12 is preferably arranged centrally and straight in the enossal implant body 2 so that uniform wall thicknesses and loads can be realized and so that the attachment of the tooth crown is simplified. Depending on the individual case, a non-central and/or oblique arrangement is also possible.

In another embodiment of the present invention, an outer force transmission element 7 is arranged above the head part 6 (see also FIG. 1). Unlike the inner force transmission element 8, the outer force transmission element 7 is not an integral part of the opening 12, but an additional distal component of the enossal implant body 2. The height of the outer force transmission element 7 can be preferably 1 to 3 mm. The outer force transmission element 7 is intended exclusively for the screwing-in of the implant body 2. A further rotational stabilization of the implant abutment 1 is not envisaged. Furthermore, the outer force transmission element 7 marks the emergence area out of the jaw bone. To avoid plaque deposition and tartar, the surface is left in a smooth state or only microstructured in the proximal area of the outer force transmission element 7. The maximum diameter of the outer force transmission element 7 matches the diameter of the base body 3.

In a preferred modified embodiment of the invention, the head part 6 and the outer force transmission element 7 form a step with a width of 0.05 to 2 mm, preferably 0.1 to 0.5 mm. A step with this width has proven particularly advantageous for improving the ingrowth and firm enclosure of the implant. In particular, the step can be formed as a flute. Through the avoidance of angular transitions, a notch effect on exposure to load with the possible consequence of material fracture is prevented. The above-mentioned widths must then be interpreted as a radius in the sense of the invention. The edge prepared as a step also makes it possible for different alveolar ridge heights to be individually balanced.

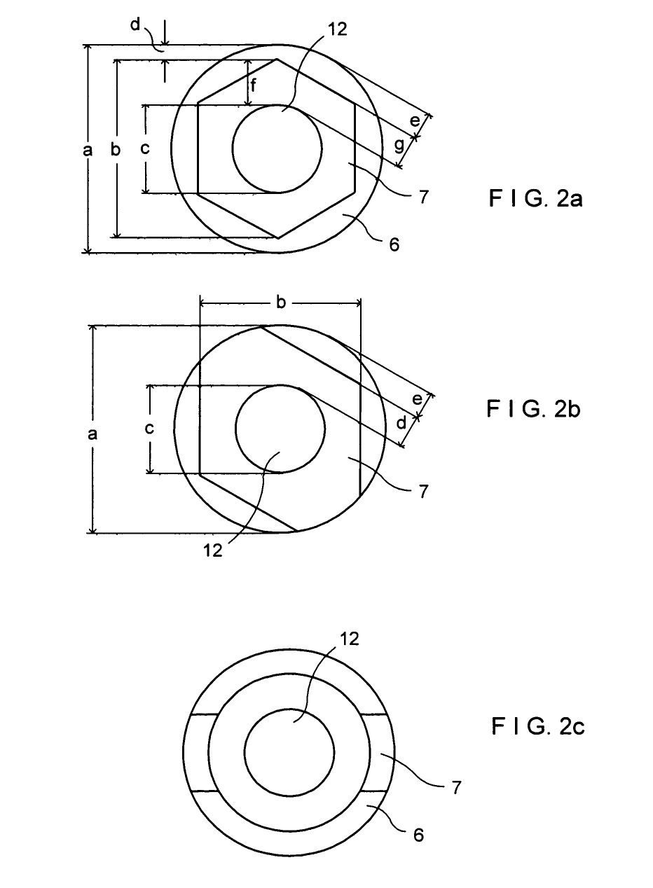

The outer force transmission element 7 can have any of the cross sections that have already been described for the inner force transmission element 8 in the present specification. The previously described teaching of the invention and its embodiments are valid and applicable without limitation to the outer force transmission element 7, in so far as this appears sensible. In a preferred embodiment of the invention, the outer force transmission element 7 is formed as a prism, preferably as a hexagonal or octagonal prism (FIG. 2a). In the former case, the screwing-in tool is a conventional hexagon socket key. Furthermore, the outer force transmission element 7 can be ground in a variety of ways (see also FIG. 2b).

In a further embodiment of the present invention, the implant abutment 1 consists of a fixing pin 9 that rests in an opening 12 of the enossal implant body 2 and a post 10 that rests on the enossal implant body 2, said fixing pin 9 and post 10 consisting of a single integral piece. The implant body 2 in this case comprises a base body 3 having the opening 12. The implant body 2 preferably has the construction already mentioned in the course of the present specification. The previously described teaching of the invention and its embodiments are valid and applicable without limitation to the enossal implant body 2 in interaction with the fixing pin 9 and post 10, in so far as this appears sensible. The implant abutment 1 represents the link between the enossal implant body 2 and the dental prosthesis, e.g. a crown. Its design is of great importance in terms of the fixing of the implant body 1 and the reception of the dental prosthesis. The shape of the implant abutment 1, both in the area of the fixing pin 9 and of the post 10, is preferably adapted with a precise fit to the corresponding shapes of the opening 12 and of the dental prosthesis, so that engaging of the various parts initially yields a positive connection.

For further stabilization of the implant system, the avoidance of micro-movements of the individual constituent parts in relation to each other or the release of the same, it is expedient to strengthen the connection further. In a preferred embodiment of the invention, the fixing pin 9 is therefore integrally joined at least to the base body 3 in the opening 12. The post 10 can also be integrally joined to the dental prosthesis.

Integral joints are all connections in which the mating parts are held together by atomic or molecular forces. In the context of the invention, bonding is applied especially. Bonding is the term given to a production process from the group of joining techniques. The adhesive adheres to the surface of the mating part by physical and/or, more rarely, by chemical interactions. The force is transmitted surface-to-surface from one mating part to the other. The requirement of large-surface bonding for sufficient strength emphasizes a bonding-adapted construction and design of the bonds. Suitable adhesives and the technical realization of bonding are known to those skilled in the art. In another preferred embodiment of the present invention, the post 10 is designed as a cylinder, cylinder with elliptical cross section, prism or cuboid with two half-cylinders on opposite side faces of the cuboid, and, moreover, the post 10 also has an identical or larger diameter than the fixing pin 9. The design of a geometrical shape with an identical diameter of the fixing pin 9 and post 10 is especially advantageous for production reasons (see also FIGS. 5a and 5d). The rotationally asymmetrical shape of the implant abutment 1 additionally permits both a precise fit in the inner force transmission element 8 and rotational stabilization of the dental prosthesis to be received. In this specific case, the fixing pin 9 has a variety of diameters and/or cross-sectional shapes.

In another preferred embodiment of the invention, the post is formed as a truncated cone whose proximal cross section has a larger diameter than the cross section of the fixing pin 9. The conical portion advantageously permits a stable anchoring of the dental prosthesis on the cone as a result of clamping action (see also FIG. 5c).

In another embodiment of the present invention, the zirconium oxide/aluminium oxide mixture contains 20 to 99.9 wt-% zirconium oxide, preferably 75 to 99.75 wt-% zirconium oxide, and 0.1 to 80 wt-% aluminium oxide, preferably 0.25 to 25 wt-% aluminium oxide. The ceramic material is biocompatible, corrosion resistant and non-ionizing. Zirconium oxide ceramics and particularly zirconium oxide/aluminium oxide ceramics have markedly better material properties than convention implant materials, e.g. titanium and aluminium oxide ceramics. ZrO₂-TZP BIO—HIP (ZrO₂/Y₂O₃/Al₂O₃) has a hardness of 1200 HV, which is greater, and a flexural strength of 1200 MPa, which is lower (by comparison, titanium has a flexural strength of 860 MPa). It has a fracture resistance of 8 K_{1c} and a Weibull modulus of 16 m. As a result, these ceramics, in terms of their physical properties, are ideally suited as tooth root substitutes. Biocompatibility tests are available for these ceramics and are all positive. The radioactivity of, for example, ZrO₂-TZP BIO—HIP, is in the biologically safe range. Further advantages include its producibility in aesthetically pleasing tooth colours and its abradability. Its osseointegration comparable to that of titanium has been histologically demonstrated. The advantageous ceramic composition of zirconium oxide and aluminium oxide is familiar to those skilled in the art (as, for instance, from DE 103 19 036 A1). The production of ceramics based on zirconium oxide, e.g. by sintering with optional hot isostatic post-densification or by hot isostatic compressing, is also known to those skilled in the art.

In a further embodiment of the invention, another oxide is added to the zirconium oxide or zirconium oxide/aluminium oxide mixture, preferably magnesium oxide, yttrium oxide or hafnium oxide. Zirconium oxide mainly occurs with a tetragonal structure, which can be stabilized by magnesium oxide or an oxide of the rare earths, preferably by yttrium oxide, which is added in quantities of 2 to 20 wt-%, preferably 4 to 10 wt-%. In a further embodiment of the present invention, 2 to 20 wt-% magnesium oxide, preferably 3.5 wt-% magnesium oxide, is added. In a further embodiment of the present invention, 2 to 20 wt-% hafnium oxide, preferably 2.2 to 3.8 wt-% hafnium oxide, is added.

In a preferred embodiment of the present invention, the zirconium oxide/aluminium oxide mixture contains 76 wt-% zirconium oxide, 20 wt-% aluminium oxide and additionally 4 wt-% yttrium oxide. This composition is known in particular as ATZ produced by Me-toxit, Thayngen (Switzerland). There are further manufacturers, and other compositions of zirconium oxides are conceivable. ATZ has even better mechanical properties than those described for ZrO₂-TZP BIO—HIP (hardness 1400 HV, flexural strength 2000 MPa). The higher elasticity of ATZ makes it possible to prevent both fractures of the abutments and edge fragmentation of the implant's abutment sheathing, even in the case of smaller diameters. This means that, for the first time, zirconium oxide ceramic implants can be used as fully adequate two-phase implants. In the development of the inventive tooth root implant from the materials mentioned, the special material- and production-related factors have been taken into account.

In another embodiment of the invention, the microstructured surface is coated with bone-active materials, preferably with hydroxyl apatite or fluoride. The surface can also be optionally coated with bone growth factors. The above-mentioned coatings are intended to accelerate and consolidate osseointegration. A microstructured surface is necessary for carrying the reactable absorbable material and thus generating a porous surface that ensures a particularly fast ingrowth of strong and permanent bone. Conventional processes for coating include, for example, plasma spraying, electrodeposition, thermal evaporation coating, thermal spraying etc., which are familiar to those skilled in the art.

It is also possible to apply only 0.5 to 2 nm thin polyelectrolyte films specifically to solid surfaces. For example, the polymer polyvinylamine makes it possible to directly influence the properties of the polyelectrolyte film from outside. By modifying the pH or degree of molecular cleavage, for example, it is possible to vary the polarity of the functional film or film thickness. Polyelectrolyte films made of polyvinylamine are extremely biocompatible and soluble in water after a desired time. Artificial dental implants coated in this way can hugely improve compatible healing. It is also conceivable for medical active agents to be bonded in precise doses to the polymer chain.

In a special embodiment of the present invention, the microstructured surface is coated with at least one soluble active agent, preferably biphosphonate, calcium, vitamin D3, calcitonin, an anabolic agent, oestrogen or an oestrogen/progestogen combination. These substances stimulating bone growth can also be embedded in a coating. They can be released by diffusion processes or from a controlled depot. Suitable bisphosphonates in the sense of the invention include, for example, alendronate, risedronate and etidronate, which are commercially available. Calcium and vitamin D3 are advantageously combined in order to boost the bone-active effect. A further bone-active agent for coating the inventive dental implant is raloxifene.

The subject-matter of the invention is also a two-part tooth root implant made of zirconium oxide or a zirconium oxide/aluminium oxide mixture with an enossal implant body 2 for anchoring in the bone and an implant abutment 1 for receiving a dental crown, said implant body 2 consisting of a cylindrical base body 3 and a cylindrical head part 6, said base body 3 having a conically convergent form in the proximal base body area 4, having an opening 12 and a thread 11 and being microstructured on the surface, and said head part 6 having a diameter identical to or smaller than the base body 3. The head part 6 preferably has a smaller diameter than the base body 3. The head part 6, like the base body 3, can be microstructured on the surface. In one embodiment, the microstructured surface of the base body 3 and/or head part 6 is coated with bone-active materials and/or at least one soluble active agent. The previously described teaching of the invention and its embodiments are valid and applicable without limitation to this last-mentioned tooth root implant.

A further subject-matter of the invention is a two-part tooth root implant made of zirconium oxide or a zirconium oxide/aluminium oxide mixture with an enossal implant body 2 for anchoring in the bone and an implant abutment 1 for receiving a dental crown, said implant body 2 consisting of a cylindrical base body 3 and a cylindrical head part 6, said base body 3 having a conically convergent form in the proximal base body area 4, having an opening 12 and a thread 11 and being microstructured on the surface by blasting with corundum, and said head part 6 having an identical or smaller diameter than the base body 3. The previously described teaching of the invention and its embodiments are valid and applicable without limitation to this last-mentioned tooth root implant, in so far as this appears sensible.

The invention also relates to a method for the placement of a tooth root implant in a jaw bone of a mammal by anchoring in the jaw bone an enossal implant body 2 made of zirconium oxide or a zirconium oxide/aluminium oxide mixture, said implant body being microstructured on the surface, by attaching an implant body 1 made of zirconium oxide or a zirconium oxide/aluminium oxide mixture to the implant body 2, and by fastening a dental crown to the implant abutment 1. The anchoring process comprises at least the introduction of the implant body 2 into the bone. A person skilled in the art is familiar with conventional methods of introduction, e.g. screwing or insertion. The implant body 2 can be introduced fully or partly into the jaw bone, preferably fully. It is possible for the distal area of the head part 6 to remain exposed, with its proximal area including the step. The latter is especially advantageous for a firm seating of the implant and for adaptation to individual alveolar ridge heights. In particular, the implant body 2 should be introduced at the location of the tooth being replaced, where a cavity in the jaw bone consequently already exists. The diseased tooth may first have to be removed and/or the cavity may have to be prepared, e.g. thoroughly cleaned and/or liberated of any tooth remains or fragments. The bone can also be widened before reception of the implant body 2, with a drilled hole, for example.

The inventive method makes use of the tooth root implant in particular to which the previously described teaching of the invention and its embodiments are applicable. Therefore, to anchor the implant in the bone, an implant body 2 is preferably used, which consists of a cylindrical base body 3 and a cylindrical head part 6, said base body having a conical convergent form for screwing into the jaw bone in the proximal base body area 4 and having a thread 11, said base body 3 and said head part 6 having an opening 12 for attachment of the implant abutment 1, and said head part 6 having an identical or smaller diameter than the base body 3.

The implant body 1 is screwed in with a tool that enters into a positive connection with an inner force transmission element 8 or an outer force transmission element 7 of the implant body 2. As to the length and construction of the force transmission elements mentioned, reference is made to the descriptions in the course of the present specification.

The introduction of the implant body advantageously follows the healing process, which is consequently an optional aspect of anchoring. To this end, after introduction of the implant body 2, the mucous membrane is sewn directly above the drilled hole. Alternatively, an oral mucous membrane former and/or the implant abutment 1 is attached for direct gingiva forming, with the sequential insertion taking place in the above-mentioned order. The gingiva grows harmoniously around this former, which is removed after a certain time and replaced by the implant abutment 1. The duration of the healing process varies from case to case and is determined, for example, by the type of mammal and the position and type of the tooth to be replaced. After this, the artificial tooth root is exposed, its state of healing checked and the implant abutment 1 fitted.

The implant abutment 1 consists of a fixing pin 9 for attaching the implant abutment 1 to the implant body 2 and a post 10 for fastening the dental crown. The process of attachment is such that the fixing pin 9 is introduced into the opening 12 at least of the base body 3. An integral joint is preferably created in this process, e.g. by bonding. It goes without saying that the integral joint demands engaging components, i.e. the shape of the opening 12 and the fixing pin 9 match accordingly. On this subject, reference is again made to the explanations given above on the inventive tooth root implant.

Finally, the dental crown or tooth prosthesis is produced with methods familiar to those skilled in the art and is fastened to the implant abutment 1. Fastening is effected by means of the post 10. This means that the dental crown has a cavity into which the post 10 engages. The previous descriptions of detailed forms of construction of the post 10 and on positive and integral joints remain valid.

The invention is explained in greater detail in the following with reference to embodiments.

FIG. 1 shows a side view of an enossal implant body 2 with an outer force transmission element 7.

FIG. 2 shows top views of alternative outer force transmission elements 7 according to FIG. 1, a) regular hexagonal prism, b) irregular body due to grinding, c) longitudinal groove.

FIG. 3 shows a side view of an enossal implant body 2 with an inner force transmission element 8.

FIG. 4 shows top views of alternative inner force transmission elements 8 according to FIG. 3, a) with a regular hexagonal cross section, b) with a rectangular cross section with two semicircular faces on two opposite rectangular faces in the distal area of the opening 12, c) with a rectangular cross section with two semicircular faces on opposite rectangular faces in the entire area of the opening 12.

FIG. 5 shows implant abutments, a) to c) rotationally symmetrical, d) to e) rotationally asymmetrical.

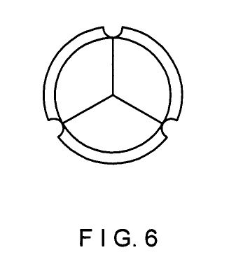

FIG. 6 shows a bottom view of the enossal implant body 2.

FIG. 1 shows an enossal implant body made of high-purity ATZ, for example, that comprises a base body 3, a head part 6, an outer force transmission element 7, a thread 11 and an opening 12. The base body 3, the head part 6 and the outer force transmission element 7 are arranged concentrically in relation to one another. The base body 3 and the head part 6 are formed rotationally symmetrically as cylinders. The thread extends over the entire height of the base body 3 of, for example, 11 mm. In the proximal area 4 of in this case 3 mm, the base body 3 tapers conically; the opening angle here is 7°. The terminal rounding is, for example, 0.2 mm. This favours the screwing-in process. The nominal diameter of the thread 11 matches the diameter of the head part 6 and is 3.75 mm in the present case. The pitch of the right-hand thread is in this case 0.41 mm; the flight depth is 0.25 mm; the rounding R at the core is 0.08 mm; and the flight opening angle is 60°. Adjoining the base body 3 is the cylindrically formed head part 6, which is intended for the deposition of the corticalis. In the embodiment, the head part 6 has a height of 1.0 mm and merges into the rotationally stable outer force transmission element 7 with a height of, for example, 1.5 mm, on which a screwing tool can engage. The transitional area has a rounding of 0.15 mm. The maximum diameter of the outer force transmission element 7 is selected as 3.65 mm in the figure, thus giving rise to an ingrowth-promoting step of a minimum of 0.05 mm. The rotational stability is achieved with a regular hexagonal prism, as represented in FIG. 2a. All the edges of the enossal implant body 2 are rounded. The precisely centrally arranged opening 12 can be designed as a cylindrical drilled hole with a diameter of 1.8 mm and a depth of 6.00 mm, which is distally widened by 0.1 mm×45°. The drilled hole is designed for receiving an inserted implant abutment 1, as shown in FIGS. 5a to 5c. The base body 3, the head part 6 and part of the outer force transmission element 7 are intended for bone deposition. To this end, the surface is enlarged by the thread 11 and additionally microstructured by sand blasting and etching. When the implant is inserted, it is intended to have the outer force transmission element 7 partly project beyond the bone edge or to close the mucous membrane over it. Before shaping for a dental crown, the outer force transmission element 7 can be subsequently prepared by the dentist with the usual diamond grinding devices with water cooling in order to create an implant-crown transition as is usual or desired for crowns on natural teeth.

FIG. 2a shows a top view of an outer force transmission element 7. The force transmission element 7 is designed as a regular hexagonal prism into which a hexagon socket key can positively engage. It is located centrally on the cylindrical head part 6 with a diameter a of, for example, 3.75 mm. The maximum diameter b of the prism is in this case 3.65 mm. The diameter c of the opening 12 is 1.8 mm in this case. The maximum distance f between the opening 12 and a prism corner is in this case 0.925 mm; the minimum distance g between the opening 12 and an outer prism face is in this case 0.725 mm. The maximum width of the step is thus 0.25 mm.

FIGS. 2b and 2c show top views of possible alternative forms of the outer force transmission element 7. The geometry in the top view of FIG. 2b is obtained with grinding on two sides. In this case, the dimensions a, b, c and e are the same as those in FIG. 2a. The minimum distance, marked d, between the opening 12 and an outer face is again 0.725 mm. If the force transmission element 7 is positioned in the mesiodistal direction of the alveolar ridge, it is possible to achieve compatibility with an alveolar ridge culminating in a point.

In FIG. 2c, rotational stabilization is achieved by two opposite longitudinal grooves.

FIG. 3 is a representation of an enossal implant body made, for example, of ATZ and consisting of a base body 3, a head part 6, an inner force transmission element 8, a thread 11 and an opening 12. With the exception of the force transmission element, the design and dimensions match those in FIG. 1. In this case, the opening 12 in the area of the head part 6 and of the distal base body area 5 is widened to 2.6 mm, for example. The depth of the inner force transmission element 8 can be 1 to 2 mm. Rotational stabilization is achieved by a cavity with a regular hexagonal cross section, as shown in FIG. 4a.

FIG. 4a shows a top view of an inner force transmission element 8. The force transmission element 8 is designed as a regular hollow prism and is located centrally in the cylindrical head part 6 with a diameter of in this case 3.75 mm.

FIGS. 4b and 4c show top views of possible alternative forms of the inner force transmission element 8. The geometry in the top view of FIG. 4b can be obtained by cutting a rectangular opening 12 in the area of the inner force transmission element 8 and then rounding the corners. Alternatively, the production of the inner force transmission element is also possible in the production process. In FIG. 4c, the opening has a rotationally asymmetrical form over its above-mentioned depth of 6.0 mm in accordance with FIG. 4b. The thickness of the ceramics between the opening 12 and the outer diameter of the head part 6 must not be less than 0.4 mm. The width of the inner force transmission element 8 is in this case determined as 1.8 mm via the diameter of the opening 12; the length here is 2.95 mm.

The implant abutments 1 represented in FIG. 5 have a total length a of, for example, 10 mm. The abutments 1 can be subdivided into a fixing pin 9 with a length b of, for example, 5.9 mm, and a post 10 with a length c of, for example, 4.0 mm. The diameter e (or f) of the fixing pin permits uncomplicated, tight-fitting insertion into a corresponding opening 12. The diameter of the rotationally symmetrical fixing pin 9 of FIGS. 5a to 5c is, for example, 1.7 mm.

In the case of the bicylindrical design of the fixing pin 9 and the post 10 in FIG. 5b, the post 10 has a different diameter d, which can be 3.0 mm, for example.

The design of the post 10 as a truncated cone, as shown in FIG. 5c, can, for example, entail a taper from 3.0 mm to 1.7 mm, the latter dimension corresponding here to the diameter of the fixing pin 9.

The rotationally asymmetrical implant abutment 1 in FIG. 5d has a cross section that can have a length b of 2.9 mm and a width c of 1.8 mm.

In the case of the differing rotationally asymmetrical design of the fixing pin 9 and the post 10 in FIG. 5e, the fixing pin 9 has a cross section that can have a length f of 2.9 mm and a width g of 1.8 mm, and the post 10 has a cross section that can have a length d of 3.25 mm and a width e of 2.4 mm.

FIG. 6 shows longitudinal recesses that interrupt the thread 11. The interruption can affect the entire thread 11 or only part thereof. In the present case, these are longitudinal grooves arranged at angles of 120°. The longitudinal grooves serve as cutting grooves by receiving bone during implantation that cannot thus impair the cutting process. In the implant's healing phase, mechanical rotational stabilization is also achieved when bone grows into the longitudinal grooves.

### DRAWING REFERENCE LIST

1 Implant abutment
2 Enossal implant body
3 Base body
4 Proximal base body area
5 Distal base body area
6 Head part
7 Outer force transmission element
8 Inner force transmission element
9 Fixing pin
10 Post
11 Thread
12 Opening

1. A two-part tooth root implant made of zirconium oxide or a zirconium oxide/aluminium oxide mixture with an enossal implant body, which is microstructured on the surface for anchoring in the bone, and an implant abutment for receiving a dental crown.

2. The tooth root implant according to claim 1, in which the implant body consists of a cylindrical base body and a cylindrical head part, said base body having an opening and a thread and having a conically convergent form in the proximal base body area, said head part having an identical or smaller diameter than the base body.

3. The tooth root implant according to claim 2, in which the opening is rotationally symmetrical.

4. The tooth root implant according to claim 3, in which the opening contains an inner force transmission element in the distal area.

5. The tooth root implant according to claim 4, in which the inner force transmission element is rotationally asymmetrical.

6. The tooth root implant according to claim 5, in which the inner force transmission element is formed with an elliptical cross section, polygonal cross section or rectangular cross section with a semicircular face, or with two semicircular faces on opposite rectangular faces.

7. The tooth root implant according to claim 2, in which the opening is rotationally asymmetrical.

8. The tooth root implant according to claim 7, in which the opening is formed with an elliptical cross section, polygonal cross section or rectangular cross section with two semicircular faces on opposite rectangular faces.

9. The tooth root implant according to claim 2, in which an outer force transmission element is arranged above the head part.

10. The tooth root implant according to claim 9, in which the head part and outer force transmission element form a step with a width of 0.05 to 2 mm.

11. The tooth root implant according to claim 9, in which the outer force transmission element is formed as a hexagonal prism or octagonal prism.

12. The tooth root implant according to claim 1, in which the implant abutment consists of a fixing pin that rests in an opening of the enossal implant body and of a post that rests on the enossal implant body, said implant body comprising a base body with the opening, and said fixing pin and post consisting of a single integral piece.

13. The tooth root implant according to claim 12, in which the fixing pin is joined integrally at least to the base body in the opening.

14. The tooth root implant according to claim 12, in which the post is formed as a cylinder, a cylinder with an elliptical cross section, a prism or a cuboid with two half-cylinders on opposite cuboid side faces, and in which the post has an identical or larger diameter than the fixing pin.

15. The tooth root implant according to claim 12, in which the post is formed as a truncated cone whose proximal cross section has a larger diameter than the cross section of the fixing pin.

16. The tooth root implant according to claim 1, in which the zirconium oxide/aluminium oxide mixture contains 20 to 99.9 wt-% zirconium oxide and 0.1 to 80 wt-% aluminium oxide.

17. The tooth root implant according to claim 1, in which a further oxide is added to the zirconium oxide or zirconium oxide/aluminium oxide mixture.

18. The tooth root implant according to claim 17, in which yttrium oxide, magnesium oxide or hafnium oxide are added.

19. The tooth root implant according to claim 18, in which 2 to 20 wt-% yttrium oxide, 2 to 20 wt-% magnesium oxide or 2 to 20 wt-% hafnium oxide are added.

20. The tooth root implant according to claim 18, in which the zirconium oxide/aluminium oxide mixture contains 76 wt-% zirconium oxide, 20 wt-% aluminium oxide and additionally 4 wt-% yttrium oxide.

21. The tooth root implant according to claim 1, in which the microstructured surface is coated with bone-active materials, at least one soluble active agent or a combination thereof.

22. The tooth root implant according to claim 21, in which the microstructured surface is coated with at least one of hydroxyl apatite, fluoride, biphosphonate, calcium, vitamin D3, calcitonin, anabolic agent, oestrogen and oestrogen/progestogen combination.

23. A two-part tooth root implant made of zirconium oxide or a zirconium oxide/aluminium oxide mixture with an enossal implant body for anchoring in the bone and an implant abutment to receive a dental crown, said implant body consisting of a cylindrical base body and a cylindrical head part, said base body having a conically convergent form in the proximal base body area, having an opening and a thread and being microstructured on the surface, and said head part having an identical or smaller diameter than the base body.

24. The tooth root implant according to claim 23, in which the head part has a smaller diameter than the base body.

25. The tooth root implant according to claim 23, in which the head part is microstructured on the surface.

26. The tooth root implant according to claim 25, in which the microstructured surface is coated with bone-active materials, at least one soluble active agent or a combination thereof.

27. A method of incorporating a tooth root implant in the jaw bone of a mammal by anchoring in the jaw bone an enossal implant body made of zirconium oxide or a zirconium oxide/aluminium oxide mixture, which implant body is microstructured on the surface, attaching an implant abutment made of zirconium oxide or a zirconium oxide/aluminium oxide mixture to the implant body, and fastening a dental crown to the implant abutment.

28. The method according to claim 27, wherein the implant body consists of a cylindrical base body and a cylindrical head part, said base body having a conically convergent form for screwing into the jaw bone in the proximal base body area base and having a thread, said base body and said head part having an opening for attachment of the implant abutment, and said head part having an identical or smaller diameter than the base body.

29. The method according to claim 28, wherein the implant body is screwed in with a tool that enters into a positive connection with an inner or outer force transmission element of the implant body.

30. The method according to claim 27, wherein the implant abutment consists of a fixing pin for attaching the implant abutment and a post for fastening the dental crown.

31. The method according to claim 27, wherein the anchoring of the implant body comprises the step of healing.
